(19) United States
(12) Patent Application Publication
(10) Pub. No.: US 2011/0290387 A1
(43) Pub. Date: Dec. 1, 2011

(54) Tire Sidewall

(75) Inventors: Patrick Pennequin, Ennezat (FR); Olivier Durel, Clermont-Ferrand (FR); Serge Semonsut, Gerzat (FR); Gilles Vidal, Perignat Les Sarlieve (FR)

(73) Assignees: Michelin Recherche et Technique S.A., Granges-Paccot (CH); Societe De Technologie Michelin, Clermont-Ferrand (FR)

(21) Appl. No.: 13/119,839

(22) PCT Filed: Sep. 18, 2009
(86) PCT No.: PCT/EP2009/062148

§ 371 Date: Aug. 10, 2011

(30) Foreign Application Priority Data
Sep. 18, 2008 (FR) 0856294

(51) Int. Cl. B60C 1/00; B60C 13/00; C08K 3/04

(52) U.S. Cl. 152/151; 524/495

(57) ABSTRACT

The invention relates to a tyre sidewall, having a rubber composition based on at least one diene elastomer, a reinforcing filler comprising carbon black and a vulcanization system, characterized in that the carbon black has a CTAB specific surface area greater than or equal to 90 m²/g and that the proportion of this carbon black is between 30 and 40 phr.

The present invention relates to a tyre having sidewalls based on a rubber composition, and more particularly to a tyre intended to be fitted onto vehicles carrying heavy loads and running at a sustained speed, such as, for example, lorries, tractor units, trailers or buses.

Certain current “road” tyres are designed to run at high speed for ever longer distances, because of the improvement in road networks and the expansion of motorway networks throughout the world. However, since fuel savings and the need to protect the environment have become a priority, it is important for the tyres to have a low energy consumption. One of the sources of energy dissipation is the heating of the tyre, especially due to the flexural stresses to which a tyre is subjected and more particularly to which the sidewalls of the tyre are subjected.

These prolonged static or dynamic stresses of the sidewalls, in the presence of ozone make weather checking or cracks that are more or less pronounced appear, the propagation of which under the effect of the persistence of the stresses may give rise to significant damage of the side wall in question.

In order to overcome the above drawback, while maintaining the properties of the sidewall in terms of low rolling resistance, good wear resistance of the sidewall with respect to scraping against pavements, good reinforcement, and conduction, the applicant has surprisingly discovered that tyre sidewalls based on rubber compositions that include, as a reinforcing filler, “fine” carbon blacks, that is to say carbon blacks that have a CTAB specific surface area greater than or equal to 90 m²/g, made it possible to overcome the aforementioned drawback while retaining a good compromise of all of the properties of the sidewall.

“Conventional” compositions for tyre sidewalls are especially described in Table 1 of Patent EP 1 097 966.

As numerous documents illustrate, among which mention may be made of documents EP 1 231 080, EP 1 526 005 and U.S. Pat. No. 7,105,595, it is known for a person skilled in the art to use more preferentially for the manufacture of sidewalls, rubber compositions based on a blend of natural rubber and synthetic rubber, “coarse” carbon blacks that correspond to an ASTM grade 300 to 700, that is to say carbon blacks having a CTAB specific surface area of less than 90 m²/g.

Contrary to the a priori knowledge of a person skilled in the art who would seek, in order to lower hysteresis of an elastomer composition for a tyre sidewall, to use coarser reinforcing fillers by reducing the volume of filler in the formulation, the applicant has discovered that, on the contrary, the use of finer fillers made it possible to lower the rolling resistance while maintaining the other performances of the sidewall.

The invention relates to a tyre sidewall, having a rubber composition based on at least one diene elastomer, a reinforcing filler comprising carbon black and a vulcanization system, characterized in that the carbon black has a CTAB specific surface area greater than or equal to 90 m²/g and that the proportion of this carbon black is between 30 and 40 phr, preferably greater than or equal to 33 phr and more preferentially still greater than or equal to 35 phr.

Advantageously, the rubber composition comprises from 35 to 55% of natural rubber or of synthetic polyisoprene, and from 65 to 45% of a diene elastomer chosen from polybutadiene, styrene-butadiene copolymers, isoprene-butadiene copolymers, isoprene-styrene copolymers and isoprene-butadiene-styrene copolymers.

Another subject of the invention is a process for preparing a tyre sidewall composition based on at least one diene elastomer, a reinforcing filler comprising carbon black and a vulcanization system, characterized in that the carbon black has a CTAB specific surface area greater than or equal to 90 m²/g and that the proportion of this carbon black is between 30 and 40 phr, and which comprises the following steps:
incorporating the carbon black into the diene elastomer by thermomechanically mixing all the ingredients, one or more times, until a maximum temperature of between 110° C. and 190° C. is reached;
cooling the mixture down to a temperature below 100° C.;
then incorporating the vulcanization system; and
mixing everything until a maximum temperature below 110° C. is reached.

The invention also relates to a tyre comprising a sidewall having a rubber composition based on at least one diene elastomer, a reinforcing filler comprising carbon black and a vulcanization system, characterized in that the carbon black has a CTAB specific surface area greater than or equal to 90 m²/g and that the proportion of this carbon black is between 30 and 40 phr, and in particular a tyre intended to be fitted onto heavy vehicles or passenger vehicles.

### I. MEASUREMENTS AND TESTS USED

The rubber compositions are characterized, before and after curing, as indicated below.

### I-1 Rolling Resistance

The rolling resistance is measured according to the ISO 9948 standard (for heavy vehicle tyres) and enables the measurement of the energy dissipated when the tyre rests against a flywheel driven by a motor and which therefore breaks the rotation of this motor.

### I-2 Crack Performance

A tyre is made to roll on a flywheel for 50 km at constant pressure and load, in which tyre an initial notch having a length of 20 mm and a depth of 1 mm has been made on the sidewall, which propagates. The performance index is the ratio between the length propagated at the surface of the control tyre over the length propagated at the surface of the tyre to be measured. Since the control has at the start an index of 100, a value above 100 indicates a better performance in terms of crack resistance.

### II—DETAILED DESCRIPTION OF THE INVENTION

In the present description, unless expressly indicated otherwise, all the percentages (%) shown are % by weight. Moreover, any interval of values denoted by the expression “between a and b” represents the range of values extending from greater than a to less than b (i.e., limits a and b excluded), whereas any interval of values denoted by the expression “from a to b” means the range of values extending from a up to b (i.e., including the strict limits a and b).

### II-1. Diene Elastomer

The term “diene” elastomer or rubber should be understood as meaning, in a known manner, an (one or more are understood) elastomer resulting at least in part (i.e., a homopolymer or a copolymer) from diene monomers (monomers bearing two carbon-carbon double bonds which may or may not be conjugated).

These diene elastomers can be classified into two categories: “essentially unsaturated” or “essentially saturated”. The term “essentially unsaturated” is understood to mean in general a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content of units of diene origin, always less than 15%). In the category of “essentially unsaturated” diene elastomers, the term “highly unsaturated” diene elastomer is understood to mean in particular a diene elastomer having a content of units of diene origin (conjugated dienes) which is greater than 50%.

Given these definitions, the term diene elastomer capable of being used in the compositions in accordance with the invention is understood more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidene norbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art of tyres will understand that the present invention is preferably employed with essentially unsaturated diene elastomers, in particular of the type (a) or (b) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers may contain between 99% and 20% by weight of diene units and between 1% and 80% by weight of vinylaromatic units. The elastomers may have any microstructure which depends on the polymerization conditions used, in particular on the presence or absence of a modifying and/or randomizing agent and on the amounts of modifying and/or randomizing agent employed. The elastomers may, for example, be block, random, sequential or microsequential elastomers and may be prepared in dispersion or in solution; they may be coupled and/or star-branched or else functionalized with a coupling and/or star-branching or functionalization agent. Mention may be made, for example, for coupling to carbon black, of functional groups comprising a C—Sn bond or amino functional groups, such as benzophenone, for example; mention may be made, for example, for coupling to a reinforcing inorganic filler, such as silica, of silanol or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The following are suitable: polybutadienes, in particular those having a content (molar %) of 1,2-units of between 4% and 80% or those having a content (molar %) of cis-1,4-units of greater than 80%, polyisoprenes, butadiene/styrene copolymers and in particular those having a T_{g} (glass transition temperature, measured according to Standard ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers, in particular those having an isoprene content of between 5% and 90% by weight and a T_{g} of −40° C. to −80° C., or isoprene/styrene copolymers, in particular those having a styrene content of between 5% and 50% by weight and a T_{g} of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2- plus 3,4-units of the isoprene part of between 5% and 70% and a content (molar %) of trans-1,4-units of the isoprene part of between 10% and 50%, and more generally any butadiene/styrene/isoprene copolymer having a T_{g} of between −20° C. and −70° C., are suitable in particular.

To sum up, the diene elastomer of the composition in accordance with the invention is preferably chosen from the group of the highly unsaturated diene elastomers consisting of polybutadienes (abbreviated to “BR”), synthetic polyisoprenes (IR), natural rubber (NR), butadiene copolymers, isoprene copolymers and the mixtures of these elastomers. Such copolymers are more preferably chosen from the group consisting of butadiene/styrene copolymers (SBR), isoprene/butadiene copolymers (BIR), isoprene/styrene copolymers (SIR) and isoprene/butadiene/styrene copolymers (SBIR).

The term “isoprene elastomer” is understood to mean, in a known manner, an isoprene homopolymer or copolymer, in other words a diene elastomer chosen from the group consisting of natural rubber (NR), synthetic polyisoprenes (IR), the various copolymers of isoprene and the mixtures of these elastomers. Mention will in particular be made, among isoprene copolymers, of isobutene/isoprene copolymers (butyl rubber—IIR), isoprene/styrene copolymers (SIR), isoprene/butadiene copolymers (BIR) or isoprene/butadiene/styrene copolymers (SBIR). This isoprene elastomer is preferably natural rubber or a synthetic cis-1,4-polyisoprene; use is preferably made, among these synthetic polyisoprenes, of the polyisoprenes having a content (molar %) of cis-1,4-bonds of greater than 90%, more preferably still of greater than 98%.

According to one particular embodiment, the composition in accordance with the invention may contain at least one essentially saturated diene elastomer, in particular at least one EPDM copolymer or one butyl rubber (optionally chlorinated or brominated), whether these copolymers are used alone or as a blend with highly unsaturated diene elastomers as mentioned above, in particular NR or IR, BR or SBR.

The compositions of the invention may contain a single diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

### II-2. Reinforcing Filler

Use is made, as reinforcing filler, of an organic filler constituted by carbon black. All reinforcing carbon blacks having a CTAB specific surface area greater than or equal to 90 m²/g are suitable as carbon blacks, which corresponds in particular to carbon blacks of the 100 or 200 series (ASTM grades), such as, for example, the N115, N134, N220 or N234 blacks. The carbon blacks might, for example, be already incorporated in the isoprene elastomer in the form of a masterbatch (see, for example, Applications WO 97/36724 or WO 99/16600).

It is specified that the CTAB specific surface area is determined according to the French standard NF T 45-007 of November 1987 (method B).

One or more other organic fillers may be combined as a blend with this carbon black, such as, for example, functionalized polyvinylaromatic organic fillers as described in Applications WO-A-2006/069792 and WO-A-2006/069793, and/or one or more reinforcing inorganic fillers such as silica.

The term “reinforcing inorganic filler” should be understood, in the present patent application, by definition, as meaning any inorganic or mineral filler (whatever its colour and its origin (natural or synthetic)), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known manner, by the presence of hydroxyl (—OH) groups at its surface.

The physical state under which the reinforcing inorganic filler is provided is not important, whether it is in the form of a powder, of micropearls, of granules, of beads or any other appropriate densified form. Of course, the term reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or pyrogenic silica exhibiting a BET surface area and a CTAB specific surface area both of less than 450 m²/g, preferably from 30 to 400 m²/g. As highly dispersible precipitated silicas (known as HDSs), mention will be made, for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or the silicas with a high specific surface area as described in Application WO 03/16837.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

For a tyre sidewall composition in accordance with the invention, use is preferably made, as reinforcing filler, of carbon black having a specific surface area greater than or equal to 90 m²/g, in a proportion between 30 and 40 phr. The term “between” is understood in the broad sense, that is to say that the proportion of carbon black is greater than or equal to 30 phr and less than or equal to 40 phr. Preferably the content of carbon black is between 33 phr and 40 phr, and more preferably between 35 phr and 40 phr.

The carbon black may advantageously constitute the sole reinforcing filler or the predominant reinforcing filler. Of course, it is possible to use this sole carbon black or a blend with one or more other carbon blacks having different ASTM grades.

### II-3. Various Additives

The rubber compositions in accordance with the invention may also comprise all or a portion of the usual additives customarily used in elastomer compositions intended for the manufacture of tyres or semi-finished products for tyres, such as, for example, other plasticizing agents (other than the plasticizing system of the invention), preferably non-aromatic or very slightly aromatic plasticizing agents, for example naphthenic or paraffinic oils, MES or TDAE oils, glycerol esters (in particular trioleates), especially natural esters, such as rapeseed or sunflower vegetable oils, pigments, protective agents, such as antiozonants, antioxidants, anti-fatigue agents, crosslinking system based either on sulphur or on sulphur donors and/or on peroxide and/or on bismaleimides, vulcanization accelerators, vulcanization activators or anti-reversion agents.

These compositions may also contain, in addition to coupling agents, coupling activators, agents for covering the inorganic fillers or more generally processing aids capable, in a known manner, by virtue of an improvement in the dispersion of the filler in the rubber matrix and a lowering of the viscosity of the compositions, of improving their ability to be processed in the green state, these agents being, for example, hydrolysable silanes, such as alkylalkoxysilanes, polyols, polyethers, primary, secondary or tertiary amines or hydroxylated or hydrolysable polyorganosiloxanes.

### II-4. Manufacture of the Rubber Compositions

The compositions are manufactured in appropriate mixers using two successive preparation phases well known to a person skilled in the art: a first phase of thermomechanical working or kneading at high temperature, up to a maximum temperature of between 110° C. and 190° C., preferably between 130° C. and 180° C., followed by a second phase of mechanical working up to a lower temperature, typically of less than 110° C., for example between 40° C. and 100° C., finishing phase during which the crosslinking system is incorporated.

The process in accordance with the invention for preparing a rubber composition for a tyre inner liner comprises the following steps:
incorporating into an elastomer at least one reinforcing filler, graphite, during a first step, by thermomechanically mixing all the ingredients, one or more times, until a maximum temperature of between 110° C. and 190° C. is reached;
then incorporating a crosslinking system during a second step;
mixing everything until a maximum temperature below 110° C. is reached.

These two steps may be carried out one after the other using the same mixer or may be separated by a step of cooling down to a temperature below 100° C., the final step then being carried out using a second mixer.

By way of example, the first phase is carried out in a single thermomechanical step during which all the necessary base constituents (elastomer, reinforcing filler and coupling agent if necessary and graphite) are firstly introduced into a suitable mixer, such as a standard internal mixer, and then secondly, for example after one to two minutes of mixing, the other additives, optional covering agents or complementary processing aids, with the exception of the crosslinking system, are introduced. After the mixture thus obtained has cooled, the crosslinking system is then incorporated in an external mixer, such as an open mill, maintained at low temperature (for example between 40° C. and 100° C.). All the ingredients are then mixed for a few minutes, for example between 2 and 15 minutes.

The crosslinking system is preferably a vulcanization system based on sulphur and on an accelerator. Use may be made of any compound capable of acting as a vulcanization accelerator for elastomers in the presence of sulphur, in particular those chosen from the group formed by 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (abbreviated to “DCBS”), N-tert-butyl-2-benzothiazyl sulphenamide (abbreviated to “TBBS”), N-tert-butyl-2-benzothiazyl sulphenimide (abbreviated to “TBSI”) and mixtures of these compounds. Preferably, a primary accelerator of the sulphenamide type is used.

Various known secondary accelerators or vulcanization activators, such as zinc oxide, stearic acid, guanidine derivatives (in particular diphenylguanidine), etc., are added to this vulcanization system during the first phase and/or during the second phase.

The final composition thus obtained is then calendered, for example in the form of a sheet or a slab, especially for laboratory characterization, or else extruded in order to form, for example, a rubber profiled element used for producing semi-finished products such as tyre sidewalls.

The vulcanization (or curing) is carried out, in a known manner, generally at a temperature of between 130° C. and 200° C. for a sufficient time, which may vary for example between 5 and 90 minutes, depending in particular on the curing temperature, on the vulcanization system adopted and on the vulcanization kinetics of the composition in question.

The following example illustrate the invention without however limiting it.

### III. EXAMPLES OF THE IMPLEMENTATION OF THE INVENTION

### III-1. Preparation of the Rubber Compositions

The tests which follow are carried out in the following way: introduced into an internal mixer, which is 70% filled and has an initial vessel temperature of approximately 90° C., are the diene elastomer (SBR and BR blend), the silica topped up with a small amount of carbon black, the coupling agent, then, after mixing for one to two minutes, the various other ingredients, with the exception of the vulcanization system. Thermomechanical working (non-productive phase) is then carried out in one step (total mixing time equal to approximately 5 minutes), until a maximum “dropping” temperature of approximately 165° C. is reached. The mixture thus obtained is recovered and cooled and then the covering agent (when the latter is present) and the vulcanization system (sulphur and sulphenamide accelerator) are incorporated thereinto on an external mixer (homofinisher) at 70° C., all the ingredients being mixed (productive phase) for approximately 5 to 6 minutes.

The compositions thus obtained are subsequently calendered, either in the form of slabs (thickness of 2 to 3 mm) or of thin sheets of rubber, for the measurement of their physical or mechanical properties, or in the form of profiled elements that can be used directly, after cutting and/or assembling to the desired dimensions, for example as semi-finished products for tyres, in particular as tyre sidewalls.

### III-2. Tests

The purpose of this example is to demonstrate the improvement in sidewalls of tyres in accordance with the invention compared to sidewalls of a “conventional” control tyre for heavy vehicles.

Tyres of size 315/60R22.5 were produced with sidewalls having compositions A, B and C respectively.

The three tyre sidewall compositions A, B and C were manufactured in accordance with the process explained in detail in the previous section. These compositions, listed in Table 1 below (where the amounts are expressed in phr or parts by weight per hundred parts of rubber (elastomer)), differ in terms of the nature and amount of their respective reinforcing filler, and also in terms of the amount of plasticizing agent used.

The formulations are given in Table 1 below.

TABLE 1

| | Composition: | | |
|---|---|---|---|
| | A | B | C |
| NR (1) | 50 | 50 | 50 |
| BR (2) | 50 | 50 | 50 |
| Carbon black (3) | 55 | — | — |
| Carbon black (4) | — | 35 | 33.5 |
| Silica (5) | — | — | 10 |
| Coupling agent (6) | — | — | 0.5 |
| Plasticizing agent (7) | 20 | 10 | 10 |
| Wax | 1 | 1 | 1 |
| Antioxidant (8) | 3 | 3 | 3 |
| ZnO | 2.5 | 2.5 | 2.5 |
| Stearic acid | 1.5 | 1.5 | 1.5 |
| Sulphur | 1.6 | 1.6 | 1.6 |
| Accelerator (9) | 1 | 1 | 1 |

(1) Natural rubber
(2) BR with 4.3% of 1,2-; 2.7% of trans-; 93% of cis-1,4-(T_{g} = −106° C.);
(3) Carbon black N330 having a CTAB specific surface area equal to 82 m²/g;
(4) Carbon black N234 having a CTAB specific surface area equal to 119 m²/g;
(5) Silica “Ultrasil VN3” from Degussa;
(6) Coupling agent TESPT (“Si69” from Degussa);
(7) MES oil (Flexon 683, Exxon Mobil);
(8) N-(1,3-Dimethylbutyl)-N-phenyl-para-phenylenediamine (Santoflex 6-PPD from Flexsys);
(9) N-cyclohexyl-2-benzothiazyl sulphenamide (Santocure CBS from Flexsys).

Thus, compositions A, B and C are defined as follows:
control composition A is a “conventional” heavy vehicle tyre sidewall composition that includes a carbon black of grade 300;
composition B, in accordance with the present invention, comprises a carbon black of grade 200 with a content lower than that used in the two control compositions;
composition C, in accordance with the invention, comprises a blend of carbon black of grade 200 and silica.

In compositions B and C, the content of plasticizing agent is lower than that of the control composition A; indeed, it is clear to a person skilled in the art that in order to obtain a satisfactory stiffness for a composition in which the content of reinforcing filler has been reduced, it is necessary to also reduce the content of plasticizing agent.

The electrical conductivity results show that the three compositions are conductive (their electrical resistivity measured being less than 10⁶ ohm), and the rolling resistance and crack performance tests are given in Table 2 below.

TABLE 2

| | Composition: | | |
|---|---|---|---|
| | A | B | C |
| Rolling resistance | Control | −0.15 kg/t | −0.13 kg/t |
| Crack performance | 100 | 400 | 137 |

It is surprisingly observed that the tyres for which the sidewalls comprise the compositions in accordance with the invention, B and C, comprising carbon black of grade 200, exhibit a substantial improvement in rolling resistance compared to the tyres comprising sidewalls that have a conventional control composition A.

Furthermore, the improvement in terms of crack performance is also very substantial as regards compositions B or C in accordance with the invention, and more particularly for composition B.

Thus the tyre sidewall compositions comprising carbon blacks having a CTAB specific surface area greater than or equal to 90 m²/g in a proportion between 30 phr and 40 phr therefore make it possible, surprisingly, to improve the rolling resistance and the crack performance while maintaining the properties of the sidewall, especially in terms of conductivity.

1. A tire sidewall, comprising a rubber composition obtained from at least one diene elastomer, a reinforcing filler comprising carbon black and a sulphur-based crosslinking system, wherein the carbon black has a CTAB specific surface area greater than or equal to 90 m²/g and wherein the proportion of this carbon black in said rubber composition is between 30 and 40 phr.

2. A tire sidewall according to claim 1, wherein the proportion of carbon black is greater than or equal to 33 phr.

3. A tire sidewall according to either one of claim 1, wherein the proportion of carbon black is greater than or equal to 35 phr.

4. A tire sidewall according to claim 1, wherein the carbon black is blended with one or more other reinforcing fillers.

5. A tire sidewall according to claim 4, wherein the carbon black is blended with one or more other organic reinforcing fillers.

6. A tire sidewall according to claim 4, wherein the carbon black is blended with one or more inorganic reinforcing fillers.

7. A tire sidewall according to claim 1, wherein the rubber composition is obtained from 35 to 55% of natural rubber or of synthetic polyisoprene, and from 65 to 45% of a diene elastomer chosen from polybutadiene, styrene-butadiene copolymers, isoprene-butadiene copolymers, isoprene-styrene copolymers and isoprene-butadiene-styrene copolymers.

8. Process for preparing a tire sidewall composition based on at least one diene elastomer, a reinforcing filler comprising carbon black and a sulphur-based crosslinking system, wherein in that the carbon black has a CTAB specific surface area greater than or equal to 90 m²/g and wherein the proportion of this carbon black is between 30 and 40 phr, and which process comprises:
incorporating the carbon black into the diene elastomer by thermomechanically mixing all the ingredients, one or more times, until a maximum temperature of between 110° C. and 190° C. is reached;
cooling the mixture down to a temperature below 100° C.;
then incorporating the vulcanization system; and
mixing everything until a maximum temperature below 110° C. is reached.

9. A tire comprising a sidewall according to claim 1.

10. A tire suitable for fitting to passenger vehicles that comprises a sidewall according to claim 1.

11. A tire suitable for fitting to heavy road vehicles that comprises a sidewall according to claim 1.
